(19) United States
(12) Patent Application Publication
(10) Pub. No.: US 2024/0327151 A1
(43) Pub. Date: Oct. 3, 2024

(54) SHEET CONVEYING DEVICE CONVEYING SHEET TO BE READ

(71) Applicant: KYOCERA Document Solutions Inc., Osaka (JP)

(72) Inventor: Kien Tran NGUYEN, Osaka (JP)

(73) Assignee: KYOCERA Document Solutions Inc., Osaka (JP)

(21) Appl. No.: 18/611,912

(22) Filed: Mar. 21, 2024

(30) Foreign Application Priority Data
Mar. 31, 2023 (JP) 2023-057309

(51) Int. Cl. B65H 5/00; B65H 5/16

(52) U.S. Cl. CPC B65H 5/006; B65H 5/16

(57) ABSTRACT

A sheet conveying device includes an ejection tray, a cover portion, a push tray, and a movable member. The ejection tray accommodates a sheet ejected thereto. The cover portion exposes the ejection tray or covers the ejection tray. The push tray pushes in a direction of ejection of the sheet the sheet ejected to the ejection tray. The movable member moves the push tray on the ejection tray in the direction of ejection of the sheet and a direction opposite to the direction of ejection of the sheet in conjunction with an operation of opening and closing the cover portion.

### INCORPORATION BY REFERENCE

This application claims priority to Japanese Patent Application No. 2023-057309 filed on Mar. 31, 2023, the entire contents of which are incorporated by reference herein.

### BACKGROUND

The present disclosure relates to sheet conveying devices.

An image reading device is known in which an original document hopper capable of feeding an original document is provided pivotally on a tray for ejected original documents.

### SUMMARY

A technique improved over the aforementioned technique is proposed as one aspect of the present disclosure.

A sheet conveying device according to an aspect of the present disclosure includes an ejection tray, a cover portion, a push tray, and a movable member. The ejection tray accommodates a sheet ejected thereto. The cover portion exposes the ejection tray or covers the ejection tray. The push tray pushes in a direction of ejection of the sheet the sheet ejected to the ejection tray. The movable member moves the push tray on the ejection tray in the direction of ejection of the sheet and a direction opposite to the direction of ejection of the sheet in conjunction with an operation of opening and closing the cover portion.

### BRIEF DESCRIPTION OF THE DRAWINGS

FIG. 1 is a view showing a multifunction peripheral including a sheet conveying device according to an embodiment of the present disclosure.

FIG. 2 is a cross-sectional view of the sheet conveying device according to the embodiment of the present disclosure.

FIGS. 3A and 3B are perspective external views of the sheet conveying device showing states where a cover portion of the sheet conveying device is opened and closed.

FIGS. 4A and 4B are perspective external views of the sheet conveying device partially exposed.

FIG. 5 is a view showing a movable member of the sheet conveying device.

FIG. 6 is a perspective external view showing the movable member and a biasing member of the sheet conveying device.

FIG. 7 is a cross-sectional side view showing a state where the cover portion of the sheet conveying device is opened.

FIGS. 8A to 8D are views showing the relationship between the operation of closing the cover portion and the movement of the movable member.

FIG. 9 is a cross-sectional side view showing a state where the cover portion of the sheet conveying device is closed.

FIGS. 10A to 10D are views showing the relationship between the operation of opening the cover portion and the movement of the movable member.

FIG. 11 is a perspective view showing an ejection tray and a push tray of the sheet conveying device as viewed from downstream toward upstream in a direction of sheet ejection (a first direction A).

### DETAILED DESCRIPTION

Hereinafter, a description will be given of a sheet conveying device according to an embodiment as an aspect of the present disclosure with reference to the drawings. Throughout the drawings, the same or equivalent parts and components are designated by the same reference characters and further description is omitted.

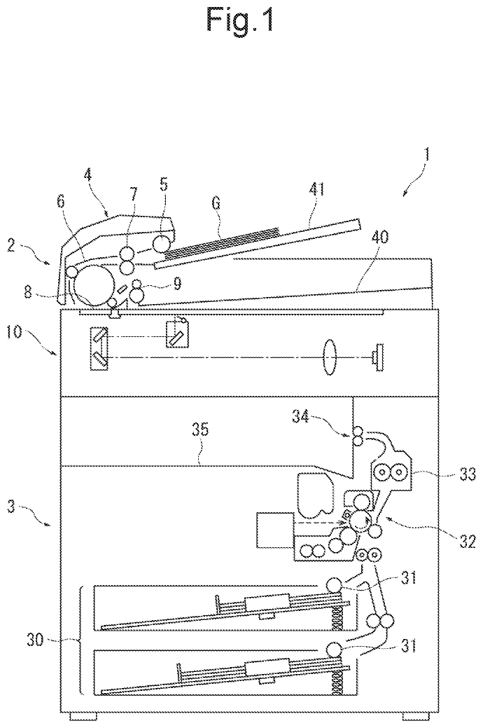

First, an outline of a multifunction peripheral 1 will be described with reference to FIGS. 1 to 3B.

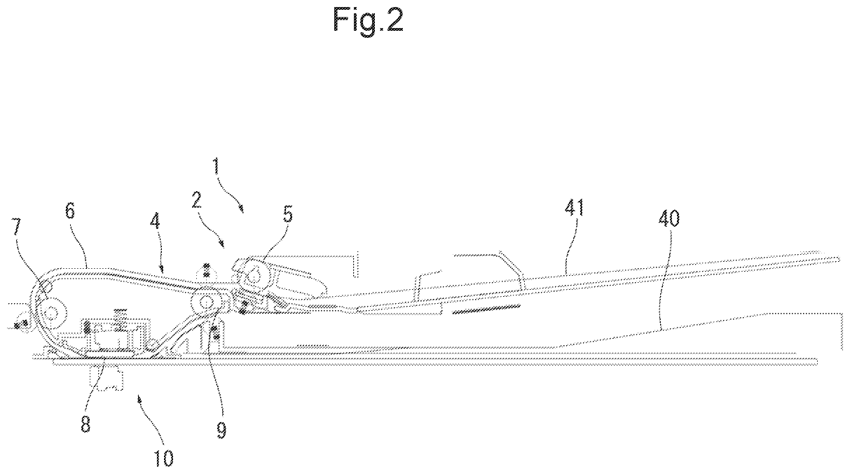

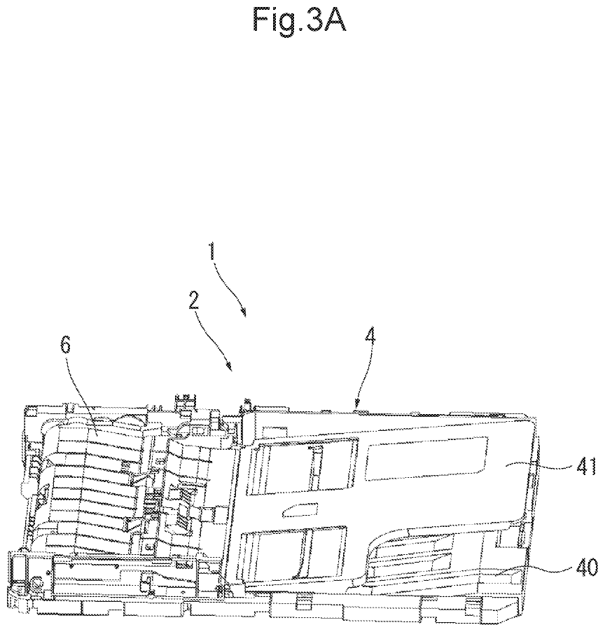

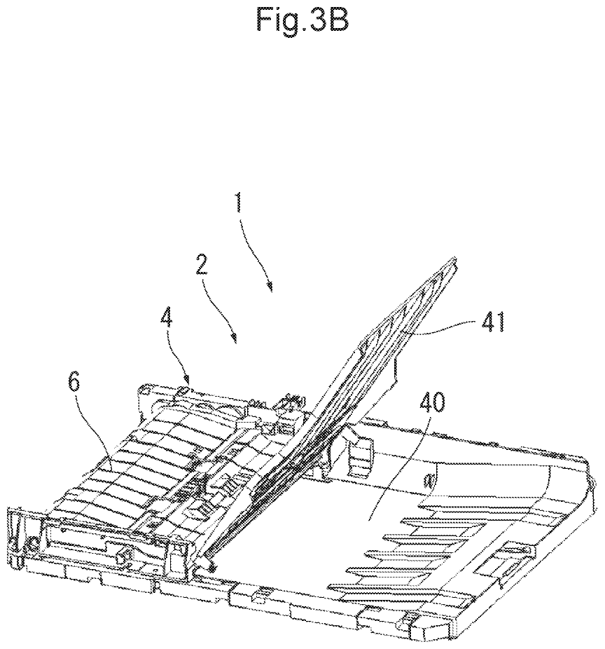

FIG. 1 is a view showing a multifunction peripheral 1 including a sheet conveying device 4 according to an embodiment of the present disclosure. FIG. 2 is a cross-sectional view of the sheet conveying device 4 according to the embodiment of the present disclosure. FIGS. 3A and 3B are perspective external views of the sheet conveying device 4 showing states where a cover portion 41 is opened and closed.

As shown in FIGS. 1 to 3B, the multifunction peripheral 1 includes a document reading apparatus 2 and an image forming apparatus 3. In this embodiment, the multifunction peripheral 1 can be described also as an image forming apparatus 1.

The document reading apparatus 2 includes a sheet conveying device 4, a sheet feed roller 5, a sheet conveyance path 6, a sheet conveyance roller 7, a reading device 8, a sheet ejection roller 9, and an optical device 10.

In the sheet conveying device 4, a sheet tray 41 (a cover portion 41) to be described hereinafter accommodates a plurality of sheets to be read by the reading device 8. Hereinafter, the sheet tray 41 will be described as the cover portion 41. The sheet to be treated by the sheet conveying device 4 may be an original document with an image formed thereon.

The sheet conveying device 4 sequentially feeds and conveys sheets accommodated by the cover portion 41 sheet by sheet to the document reading apparatus 2. The sheet conveying device 4 ejects the fed sheet to an ejection tray 40 to be described hereinafter. The sheet conveying device 4 includes, for example, an ADF (auto document feeder).

The sheet feed roller 5 picks up the sheets accommodated by the cover portion 41 sheet by sheet and feeds it to the sheet conveyance path 6.

The sheet conveyance path 6 is formed to extend from the cover portion 41 via the reading device 8 to the ejection tray 40.

The sheet conveyance roller 7 is disposed in the sheet conveyance path 6 and rotates to convey to the reading device 8 the sheet fed from the cover portion 41. A plurality of sheet conveyance rollers 7 may be disposed in the sheet conveyance path 6.

The reading device 8 is provided with a slit-like platen glass extending in a sheet width direction orthogonal to a direction of sheet ejection (a direction of ejection of the sheet). An image formed on the surface of the sheet conveyed to the location of the reading device 8 is read by the optical device 10 located below the reading device 8.

The sheet ejection roller 9 ejects to the ejection tray 40 the sheet the image of which has been read in the reading device 8.

In reading a sheet having been conveyed to the location of the reading device 8, the optical device 10 is positioned below the reading device 8. The optical device 10 applies light to the sheet, receives light reflected from the sheet, and outputs image data based on the reflected light. As an example, the optical device 10 includes a light-emitting part, a reflective member, and a light-receiving part formed of a CCD (charge coupled device) or so on. For the purpose of reading images formed on both sides of a sheet, an optical reading device formed of a CIS (contact image sensor) or so on may be further disposed in the sheet conveyance path 6 and across the sheet from the optical device 10.

Furthermore, as shown in FIG. 1, the image forming apparatus 3 includes a sheet tray 30, a sheet feed roller 31, an image forming device 32, a fixing device 33, a sheet output roller 34, and a sheet output tray 35.

The sheet tray 30 accommodates sheets. The sheet feed roller 31 feeds a sheet from the sheet tray 30 to the image forming device 32. The image forming device 32 forms an image on the sheet fed by the sheet feed roller 31.

As an example, the image forming device 32 includes, a photoconductor, a charging device, an exposure device, a developing device, a transfer device, a cleaning device, and a destaticizing device.

The charging device charges the peripheral surface of the photoconductor. The exposure device exposes the peripheral surface of the photoconductor to light based on the image data to form an electrostatic latent image on the peripheral surface of the photoconductor. The developing device develops the electrostatic latent image by toner to form a toner image on the peripheral surface of the photoconductor.

When the transfer device is in the direct transfer system, it transfers the toner image on the photoconductor to a sheet. When the transfer device is in the indirect transfer system, it primarily transfers the toner image on the photoconductor to an intermediate transfer member and then secondarily transfers the toner image from the intermediate transfer member to a sheet.

The cleaning device cleans residual toner from the peripheral surface of the photoconductor. The destaticizing device removes electric charge on the peripheral surface of the photoconductor.

The fixing device 33 applies heat and pressure to the sheet to fix the toner image on the sheet.

The sheet output roller 34 ejects the sheet with the toner image fixed thereon to the sheet output tray 35. The sheet output tray 35 accommodates sheets having toner images formed thereon.

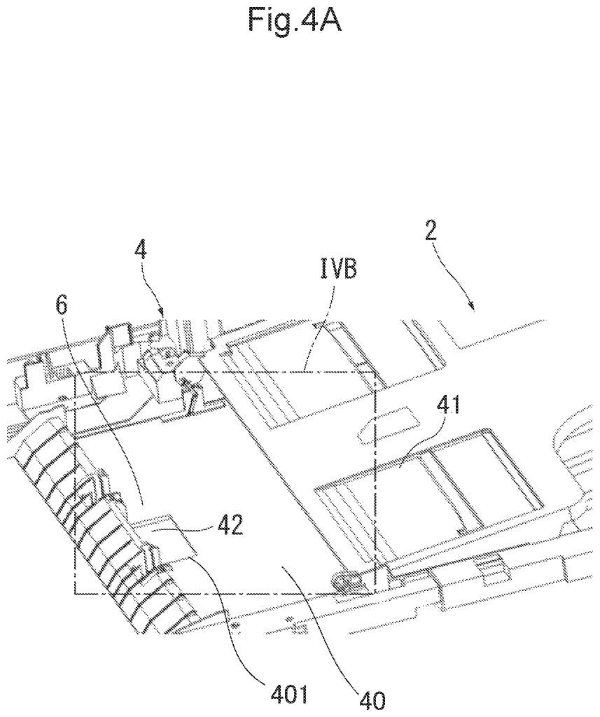

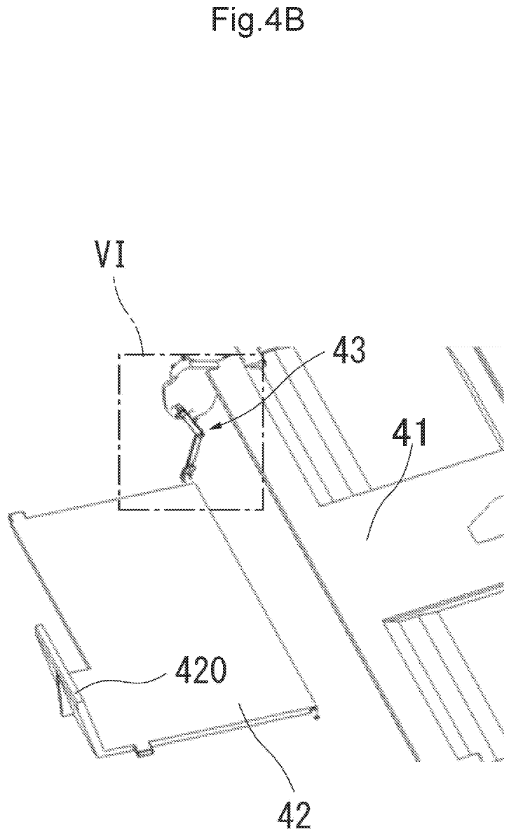

Next, the sheet conveying device 4 will be described with reference to FIGS. 1 to 3B as well as FIGS. 4A to 6.

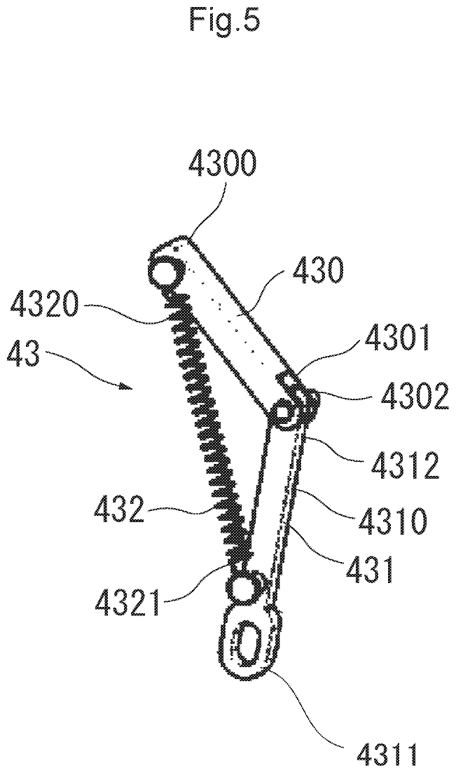

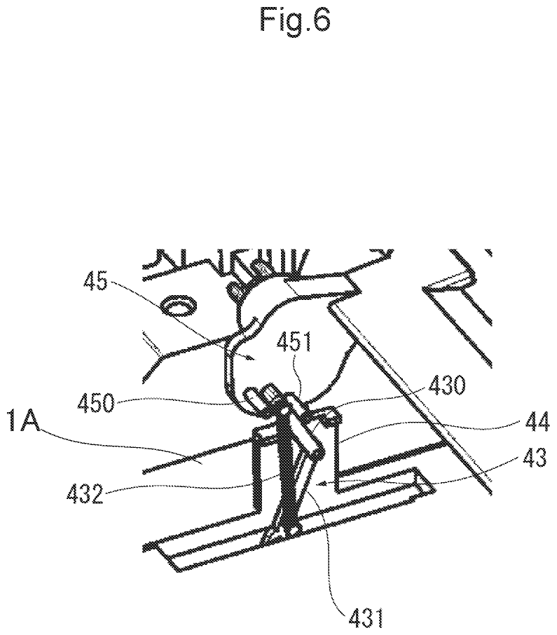

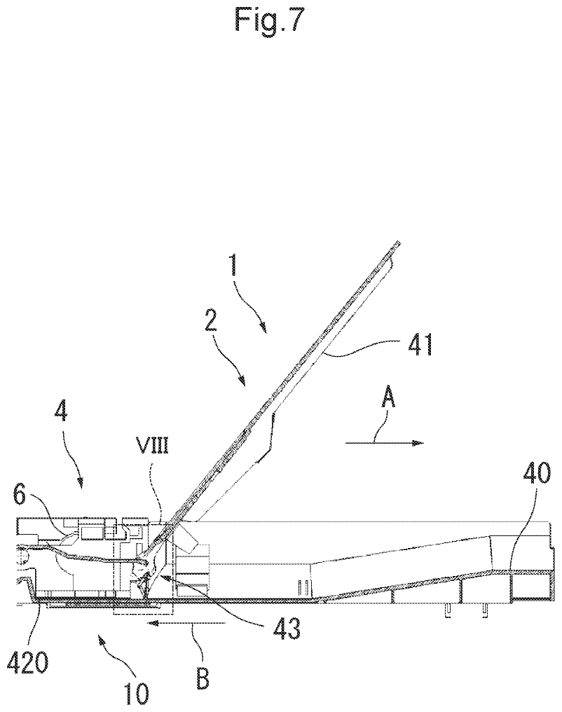

FIG. 4A is a perspective external view showing in detail part of the ejection tray 40 of the sheet conveying device 4. FIG. 4B is a perspective external view showing in magnification the region IVB shown in FIG. 4A. FIG. 5 is a perspective external view showing a movable member 43 of the sheet conveying device 4. FIG. 6 is an enlarged view of the region VI shown in FIG. 4B and a perspective external view showing the movable member 43 and a biasing member 45 of the sheet conveying device 4. FIG. 7 is a cross-sectional side view showing a state where the cover portion 41 of the sheet conveying device 4 is opened.

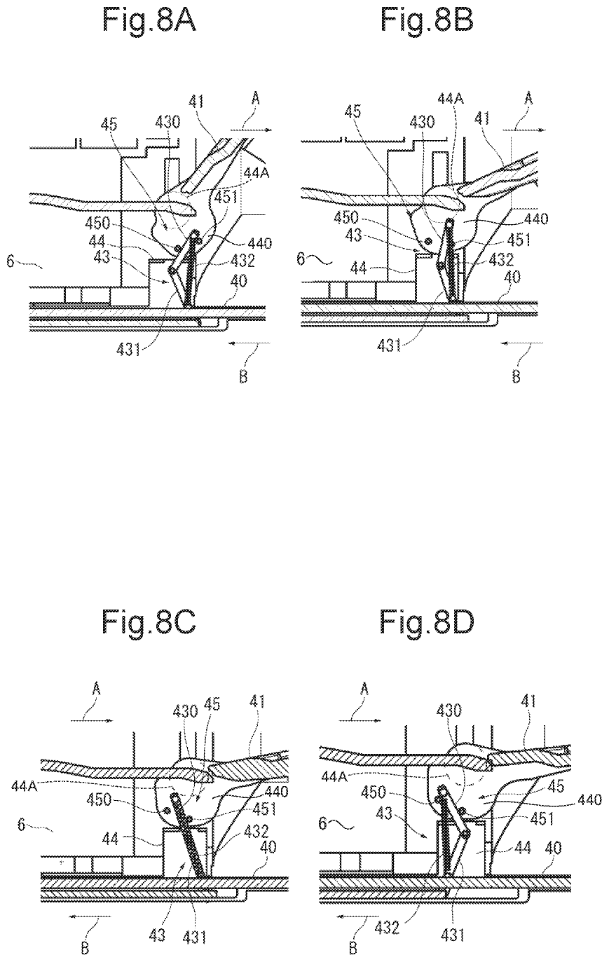

The sheet conveying device 4 includes: the ejection tray 40 shown in FIGS. 1 to 3B; the cover portion 41; a push tray 42 shown in FIGS. 4A and 4B; the movable member 43 shown in FIGS. 4B to 6; a support 44 shown in FIGS. 8A and 8B; and the biasing member 45 shown in FIGS. 8A to 10B. The support 44 is provided on a device body 1A of the sheet conveying device 4 and supports the movable member 43.

The ejection tray 40 shown in FIG. 1 accommodates ejected sheets.

The cover portion 41 exposes the ejection tray 40 or covers the ejection tray 40. Specifically, the cover portion 41 is pivotally mounted to the sheet conveying device 4 to expose or cover the ejection tray 40. The cover portion 41 includes an end portion located at a lateral side thereof in a direction orthogonal to the direction of sheet ejection and located at an upstream end thereof in the direction of sheet ejection and the end portion serves as the biasing member 45. The biasing member 45 is supported by the device body 1A (see FIG. 6) of the sheet conveying device 4 to allow the cover portion 41 to pivotally move in a direction toward and away from the ejection tray 40. The biasing member 45 is formed, as an example, by a root end portion of the cover portion 41 (see FIG. 8A).

The push tray 42 is a tray that pushes out a sheet ejected to the ejection tray 40.

The movable member 43 moves the push tray 42 on the ejection tray 40 in conjunction with the operation of opening and closing the cover portion 41.

Next, the movable member 43 will be described in detail still with reference to FIGS. 4B to 6.

As shown in FIG. 5, the movable member 43 includes a first arm 430, a second arm 431, and an elastic member 432.

The first arm 430 includes a first upper end portion 4300 and a first lower end portion 4301. The first lower end portion 4301 includes a first connecting portion 4302 pivotally supported by the support 44.

The second arm 431 includes a second upper end portion 4310 and a second lower end portion 4311. The second upper end portion 4310 includes a second connecting portion 4312 supported by the support 44 pivotally about the same pivot axis as for the first lower end portion 4301.

The elastic member 432 includes an elastic upper end portion 4320 and an elastic lower end portion 4321. An example of the elastic member 432 is a tension spring.

The first connecting portion 4302 of the first lower end portion 4301 of the first arm 430 and the second connecting portion 4312 of the second upper end portion 4310 of the second arm 431 are pivotally connected to each other.

The second lower end portion 4311 of the second arm 431 is pivotally connected to the push tray 42.

The first arm 430 is pivotally connected at the first upper end portion 4300 thereof to the elastic upper end portion 4320 of the elastic member 432.

The second arm 431 is pivotally connected at the second lower end portion 4311 thereof to the elastic lower end portion 4321 of the elastic member 432.

In this embodiment, the push tray 42 is moved suitably using the principle of leverage of the first arm 430 and the second arm 431 of the movable member 43 and the elastic force of the elastic member 432.

Next, with reference to FIGS. 7 to 8B, a description will be given of the relationship between the operation of moving the cover portion 41 from a position to open the ejection tray 40 to a position to face and close the ejection tray 40 and the movement of the movable member 43

FIG. 7 is a view showing a state where the cover portion 41 of the sheet conveying device 4 is opened. FIGS. 8A to 8D are views showing the relationship between the operation of closing the cover portion 41 and the movement of the movable member 43. FIGS. 8A to 8D are views showing in magnification the region VIII shown in FIG. 7.

As described previously, the biasing member 45 of the cover portion 41 is supported by the device body 1A of the sheet conveying device 4 to allow the cover portion 41 to pivotally move in the direction toward and away from the ejection tray 40. A side surface 440 of the biasing member 45 directed to the center of the ejection tray 40 in the sheet width direction is provided with a second pin 451 and a first pin 450 both of which extend in the sheet width direction and are spaced a certain distance from each other. In other words, the biasing member 45 includes: the first pin 450 disposed upstream of the first arm 430 in the direction of sheet ejection above the ejection tray 40; and the second pin 451 disposed downstream of the first arm 430 in the direction of sheet ejection above the ejection tray 40.

Furthermore, the biasing member 45 pivots about a pivot shaft 44A shown by the broken line in FIGS. 8A to 8D. In a state where the first upper end portion 4300 of the first arm 430 of the movable member 43 is located between the second pin 451 and the first pin 450, the first arm 430 is supported pivotally about the first connecting portion 4302 by the support 44. In other words, the biasing member 45 includes: the first pin 450 located upstream of the first arm 430 in the direction of sheet ejection (the first direction A) above the ejection tray 40; and the second pin 451 located downstream of the first arm 430 in the first direction A above the ejection tray 40. The first upper end portion 4300 is provided with a projection that extends toward and abuts on the side surface 440 of the biasing member 45. However, the first upper end portion 4300 is not fixed to the biasing member 45 and moves independently from the biasing member 45. The biasing member 45 changes the posture of the movable member 43 in conjunction with the pivotal movement of the cover portion 41.

A description will be given below of the movements of the movable member 43 and the push tray 42 in pivoting the cover portion 41 having the above structure from an open state shown in FIG. 7 in a direction to cover the ejection tray 40, i.e., in a direction toward the ejection tray 40 (a direction to close the ejection tray 40).

While the cover portion 41 is pivoted in the direction toward the ejection tray 40 from the open state to the position to close the ejection tray 40, the cover portion 41 pivotally moves in the order shown in FIGS. 8A, 8B, 8C, and 8D. In this case, in a state where the cover portion 41 is open, the first arm 430 of the movable member 43 tends to pivot clockwise in FIG. 8A about the first connecting portion 4302 by the biasing force of the elastic member 432, but is blocked from this pivoting by the second pin 451. Therefore, the first arm 430 takes a posture shown in FIG. 8A.

When, as shown in FIG. 8B, the cover portion 41 pivots in the direction toward the ejection tray 40 from the open state, the second pin 451 pivots clockwise in FIG. 8B and moves in a second direction B shown in FIG. 8B. At this time, the first arm 430 is pushed in the second direction B by the second pin 451 to pivot in the second direction B (counterclockwise in FIG. 8B) about the first connecting portion 4302 and the second connecting portion 4312 of the second arm 431 against the biasing force of the elastic member 432. Then, when the cover portion 41 further pivots in the direction toward the ejection tray 40, the first upper end portion 4300 moves, as shown in FIG. 8C, upstream of the first connecting portion 4302 in the direction of sheet ejection (the first direction A) above the ejection tray 40, i.e., moves further in the second direction B with respect to the first connecting portion 4302.

When the cover portion 41 even further pivots in the direction toward the ejection tray 40 from the state shown in FIG. 8C (see FIG. 8D), the first arm 430 is further pushed in the second direction B by the second pin 451 to tend to move further upstream of the first connecting portion 4302 in the direction of sheet ejection (the first direction A) above the ejection tray 40, i.e., tend to move even further in the second direction B with respect to the first connecting portion 4302. At this time, a biasing force based on a tensile force of the elastic member 432 acts between the first upper end portion 4300 of the first arm 430 and the second lower end portion 4311 of the second arm 431. By the biasing force, as shown in FIG. 8D, the first arm 430 pivots further counterclockwise about the first connecting portion 4302, engages against the first pin 450, and thus stops pivoting. In the meantime, the second arm 431 pivots clockwise (in the second direction B) about the second connecting portion 4312 by the tensile force of the elastic member 432. By this pivoting, the second lower end portion 4311 of the second arm 431 moves in the second direction B.

The second lower end portion 4311 of the second arm 431 of the movable member 43 includes an axially elongated slot formed therein and a cylindrical projection extending from the push tray 42 is engaged pivotally and axially slidably in the elongated slot. Thus, the second lower end portion 4311 of the second arm 431 pushes the push tray 42 connected to the second lower end portion 4311 upstream in the direction of sheet ejection along the ejection tray 40, i.e., pushes it in a direction opposite to the direction of sheet ejection (in the second direction B).

In other words, the biasing force of the elastic member 432 acts to pivot the second arm 431 of the movable member 43 about the first connecting portion 4302 and the second connecting portion 4312 of the second arm 431 in the order shown in FIGS. 8A, 8B, 8C, and 8D. While the first upper end portion 4300 of the first arm 430 is located downstream of the axis of the second arm 431 in the first direction A, the biasing force of the elastic member 432 acts to pivot the second arm 431 counterclockwise about the second connecting portion 4312 and, thus, the second lower end portion 4311 stays at a position where the second lower end portion 4311 has moved to its downstream moving end in the first direction A. When the first upper end portion 4300 of the first arm 430 moves upstream of the axis of the second arm 431 in the first direction A, the biasing force of the elastic member 432 acts to pivot the second arm 431 clockwise and, thus, the second lower end portion 4311 moves to its upstream moving end in the first direction A. As a result, a force to push the push tray 42 connected to the second lower end portion 4311 upstream in the direction of sheet ejection along the ejection tray 40, i.e., push it in the direction opposite to the direction of sheet ejection (in the second direction B), is created.

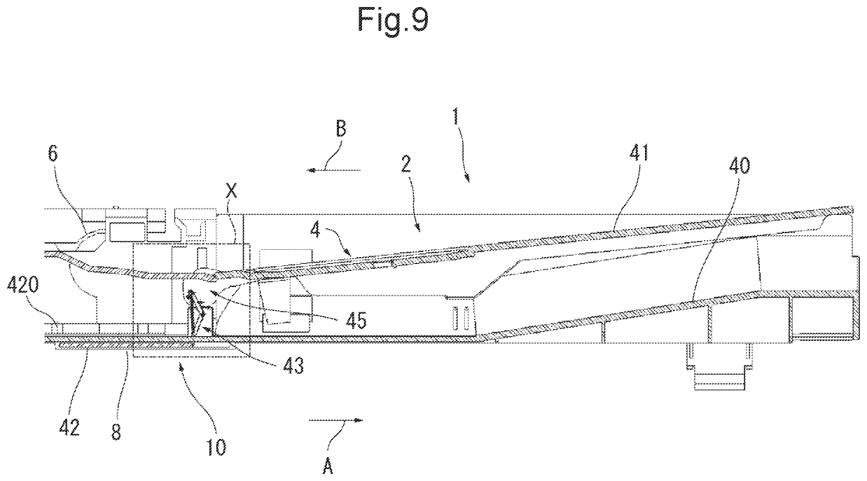

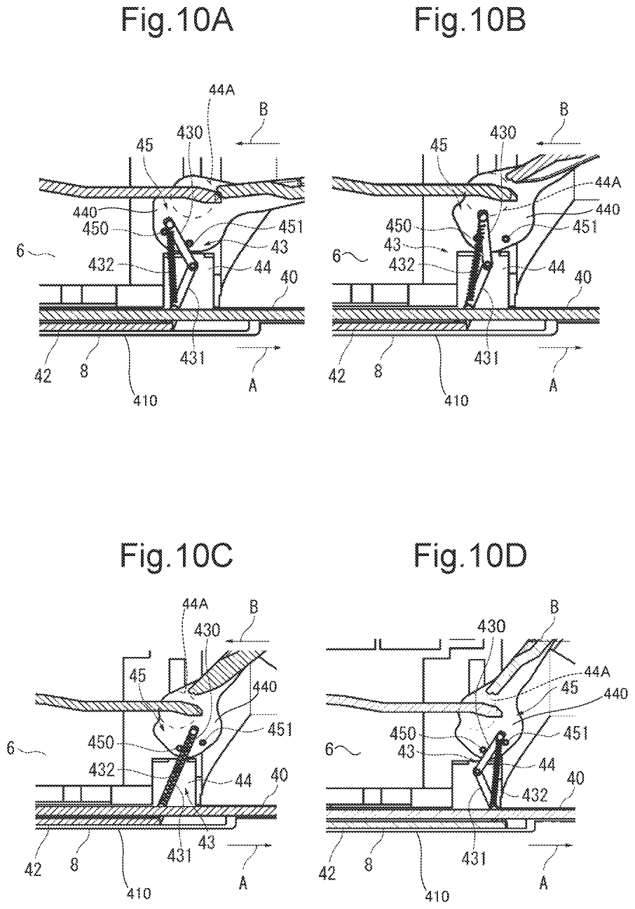

In accordance with this embodiment, with a user's easy operation of closing the cover portion 41, the first pin 450 pushes the first arm 430, the second lower end portion 4311 of the second arm 431 is thus pushed in the second direction B. In this manner, the user can push the push tray 42 toward the upstream moving end in the direction of sheet ejection (retract the push tray 42 inward within the sheet conveying device 4). Next, with reference to FIGS. 9 to 10D, a description will be given of the relationship between the operation of opening the cover portion 41 and the movement of the movable member 43

FIG. 9 is a cross-sectional side view showing a state where the cover portion 41 of the sheet conveying device 4 is closed. FIGS. 10A to 10D are views showing the relationship between the operation of moving the cover portion 41 from the closed state to the open state and the movement of the movable member 43. FIGS. 10A to 10D are views showing in magnification the region X shown in FIG. 9.

A description will be given below of the movements of the movable member 43 and the push tray 42 in pivoting the cover portion 41 from the closed state shown in FIG. 9 in a direction to open the ejection tray 40, i.e., in a direction away from the ejection tray 40.

In a state where the cover portion 41 is closed, as shown in FIG. 10A, the first arm 430 engages with the first pin 450 at a position where the first upper end portion 4300 has moved in the second direction B with respect to the first connecting portion 4302.

When the cover portion 41 pivots in the direction away from the ejection tray 40 from the state shown in FIG. 10A (see FIG. 10B), the biasing member 45 pivots counterclockwise in FIG. 10B and the first pin 450 also pivots counterclockwise along with the pivoting of the biasing member 45 and moves in the first direction A. Thus, the first am 430 is pushed in the first direction A by the first pin 450 and moves downstream in the direction of sheet ejection with respect to the first connecting portion 4302 above the ejection tray 40, i.e., moves in the first direction A with respect to the first connecting portion 4302.

When the cover portion 41 further pivots in the direction away from the ejection tray 40 from the above state, as shown in FIG. 10C, the first pin 450 further pivots counterclockwise in FIG. 10C and further moves in the first direction A. At this time, the first arm 430 is pushed in the first direction A by the first pin 450 to pivot clockwise in FIG. 10C (in the first direction A) about the first connecting portion 4302 against the biasing force of the elastic member 432.

When the cover portion 41 further pivots in the direction away from the ejection tray 40 from the state shown in FIG. 10C, the first pin 450 further pivots counterclockwise, further moves in the first direction A, and thus further pushes the first arm 430 in the first direction A. Thus, when, as shown in FIG. 10D, the cover portion 41 is pivoted to the position to open the ejection tray 40, the first arm 430 is further pushed in the first direction A by the first pin 450 and thus pivots to a posture where the first upper end portion 4300 is located downstream of the first connecting portion 4302 in the first direction A. At this time, a biasing force based on a tensile force of the elastic member 432 acts between the first upper end portion 4300 of the first arm 430 and the second lower end portion 4311 of the second arm 431. By the biasing force, as shown in FIG. 10D, the first arm 430 pivots further clockwise about the first connecting portion 4302, moves in the first direction A, engages against the second pin 451, and thus stops pivoting. In the meantime, the second arm 431 pivots counterclockwise (in the first direction A) about the second connecting portion 4312 by the tensile force of the elastic member 432. By this pivoting, the second lower end portion 4311 of the second arm 431 moves in the first direction A.

Since, as described previously, the second lower end portion 4311 of the second arm 431 of the movable member 43 includes the axially elongated slot formed therein and the cylindrical projection extending from the push tray 42 is engaged pivotally and axially slidably in the elongated slot, the second lower end portion 4311 of the second arm 431 pulls out the push tray 42 connected to the second lower end portion 4311 downstream in the direction of sheet ejection along the ejection tray 40, i.e., pulls out the push tray 42 in the first direction A.

In other words, the second arm 431 of the movable member 43 pivots counterclockwise in the order shown in FIGS. 10A, 10B, 10C, and 10D along with the pivoting of the first arm 430 about the first connecting portion 4302 and the second connecting portion 4312 of the second arm 431. While the first upper end portion 4300 of the first arm 430 is located upstream of the axis of the second arm 431 in the first direction A, the biasing force of the elastic member 432 acts to pivot the second arm 431 clockwise and, thus, the second lower end portion 4311 stays at a position where the second lower end portion 4311 has moved to its upstream moving end in the first direction A (see FIG. 10A). When the first upper end portion 4300 of the first arm 430 moves downstream of the axis of the second arm 431 in the first direction A, the biasing force of the elastic member 432 acts to pivot the second arm 431 counterclockwise and, thus, the second lower end portion 4311 moves downstream in the first direction A.

In accordance with this embodiment, by performing the operation of opening the cover portion 41, the user can pull out the push tray 42 in the direction of sheet ejection (the first direction A) from the ejection tray 40.

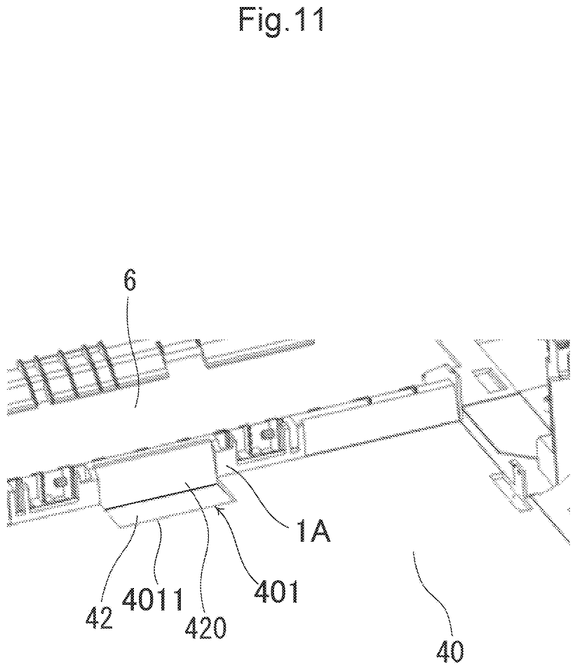

Next, the push tray 42 will be described with reference to FIGS. 4A, 4B, 8A, and 11. FIG. 11 is a perspective view showing the ejection tray 40 and the push tray 42 of the sheet conveying device 4 as viewed from downstream toward upstream in the direction of sheet ejection (the first direction A).

As shown in FIG. 4A, an opening 401 through the ejection tray 40 is provided at an upstream end portion of the ejection tray 40 in the direction of sheet ejection (the first direction A) and, for example, in the middle of the ejection tray 40 in the sheet width direction. Furthermore, as shown in FIG. 10A, a push tray housing 410 that accommodates the push tray 42 to allow sliding movement of the push tray 42 in both the first direction A and the second direction B is provided under the ejection tray 40.

Moreover, as shown in FIG. 4B, a support wall 420 stands from an upstream end of the push tray 42 in the direction of sheet ejection. The push tray 42 is accommodated in the push tray housing 410 to allow the support wall 420 to pass through the opening 401 in the ejection tray 40 and become exposed above the ejection tray 40. Along with sliding movement of the push tray 42 in the first direction A and the second direction B, the support wall 420 moves in the first direction A and the second direction B within a range of movement corresponding to the length of the opening 401 in the first direction A and the second direction B. In other words, the sliding movement of the push tray 42 is restricted by the engagement of the support wall 420 against the device body 1A (see FIG. 11) and the engagement of the support wall 420 against an edge 4011 (see FIG. 11) of the opening 401.

In a state where the cover portion 41 is closed, the push tray 42 is located on the upstream side in the direction of sheet ejection (the first direction A) and, at the time, the support wall 420 has already reached a position of abutment against the device body 1A (see FIG. 11). When the cover portion 41 is in this state, a sheet is ejected onto the ejection tray 40 and placed on the ejection tray 40.

Then, as described previously, when the cover portion 41 is pivoted from the closed state to the open state, the push tray 42 slides in the direction of sheet ejection (the first direction A), during which the support wall 420 moves in the first direction A within the opening 401 until it abuts against the downstream edge 4011 (see FIG. 11) of the opening 401 in the direction of sheet ejection (the first direction A).

During the movement of the support wall 420 as just described, the support wall 420 moves while abutting on an end of a sheet (an upstream end thereof in the direction of sheet ejection) placed on the ejection tray 40 and pushing the sheet in the direction of sheet ejection. Thus, the sheet placed on the ejection tray 40 can be further moved in the direction of sheet ejection. This is useful, for example, when a small-sized sheet (a sheet shorter in the direction of sheet ejection than a standard-sized sheet) is ejected onto the ejection tray 40, to further move the small-sized sheet in the direction of sheet ejection to a position where the user can easily pick it up.

In the conventional sheet conveying device not equipped with the push tray 42 having the above structure, even when the original document hopper is lifted to expose the tray for ejected original documents, an ejected small-sized original document may be difficult to pick up from the tray for ejected original documents. Unlike this, in the above embodiment, a small-sized sheet ejected onto the ejection tray 40 can be easily picked up.

The description of the embodiment of the present disclosure has so far been given with reference to the drawings. However, the present disclosure is not limited to the above embodiment and can be implemented in various forms without departing from the gist of the present disclosure. For the sake of ease of understanding, the drawings may be schematic representation, primarily of components. The number of components and so on shown in the drawings may be different from those of actual components for convenience of creation of the drawings. The components described in the above embodiment are merely illustrative, not particularly limited, and can be changed variously without substantially departing from the effects of the present disclosure.

### INDUSTRIAL APPLICABILITY

The present disclosure is applicable to the field of sheet conveying devices.

While the present disclosure has been described in detail with reference to the embodiments thereof, it would be apparent to those skilled in the art the various changes and modifications may be made therein within the scope defined by the appended claims.

What is claimed is:

1. A sheet conveying device comprising:
an ejection tray that accommodates a sheet ejected thereto;
a cover portion that exposes the ejection tray or covers the ejection tray;
a push tray that pushes in a direction of ejection of the sheet the sheet ejected to the ejection tray; and
a movable member that moves the push tray on the ejection tray in the direction of ejection of the sheet and a direction opposite to the direction of ejection of the sheet in conjunction with an operation of opening and closing the cover portion.

2. The sheet conveying device according to claim 1, wherein
the cover portion includes an end portion located at a lateral side thereof in a direction orthogonal to the direction of ejection of the sheet and located at an upstream end thereof in the direction of ejection of the sheet and is supported at the end portion by a device body of the sheet conveying device pivotally in a direction toward and away from the ejection tray,
the sheet conveying device further comprises a support provided on device body to support the movable member,
the movable member comprises:
a first arm including a first upper end portion and a first lower end portion, the lower end portion including a first connecting portion pivotally supported by the support;
a second arm including a second upper end portion and a second lower end portion, the second upper end portion including a second connecting portion supported by the support pivotally about the same pivot axis as for the first lower end portion; and
an elastic member including an elastic upper end portion and an elastic lower end portion,
the first connecting portion of the first lower end portion and the second connecting portion of the second upper end portion are pivotally connected to each other,
the second lower end portion is pivotally connected to the push tray,
the first arm is capable of abutting at the first upper end portion against the end portion of the cover portion to pivot along with pivoting of the end portion of the cover portion,
the elastic upper end portion is pivotally connected to the first upper end portion, and
the elastic lower end portion is pivotally connected to the second lower end portion.

3. The sheet conveying device according to claim 2, wherein when the cover portion pivots to a position to cover the ejection tray, the first arm pivots in a direction opposite to the direction of ejection of the sheet about the first connecting portion and the second connecting portion to allow the first upper end portion to move upstream of the first connecting portion in the direction of ejection of the sheet above the ejection tray, and the second arm pivots in the direction opposite to the direction of ejection of the sheet about the first connecting portion and the second connecting portion to allow the second lower end portion to move upstream of the second connecting portion in the direction of ejection of the sheet above the ejection tray and pushes the push tray in the direction opposite to the direction of ejection of the sheet along the ejection tray to move the push tray to an upstream side of the ejection tray.

4. The sheet conveying device according to claim 3, wherein
the end portion of the cover portion serves as a biasing member that changes a posture of the movable member in conjunction with pivoting of the cover portion,
the biasing member comprises:
a first biasing member disposed upstream of the first arm in the direction of ejection of the sheet above the ejection tray; and
a second biasing member disposed downstream of the first arm in the direction of ejection of the sheet above the ejection tray,
when the cover portion pivots from a position to open the ejection tray to the position to cover the ejection tray, the second biasing member moves in the direction opposite to the direction of ejection of the sheet above the ejection tray to pivot the first arm in the direction opposite to the direction of ejection of the sheet and push the first arm until the first upper end portion of the first arm moves upstream of the first connecting portion in the direction of ejection of the sheet above the ejection tray.

5. The sheet conveying device according to claim 4, wherein when the cover portion pivots to the position to open the ejection tray, the first biasing member moves in the direction of ejection of the sheet above the ejection tray to pivot the first arm in the direction of ejection of the sheet and push the first arm until the first upper end portion of the first arm moves downstream of the first connecting portion in the direction of ejection of the sheet above the ejection tray.

6. The sheet conveying device according to claim 2, wherein when the cover portion pivots from a position to cover the ejection tray to a position to open the ejection tray, the first arm pivots in the direction of ejection of the sheet about the first connecting portion and the second connecting portion to move the first upper end portion downstream of the first connecting portion in the direction of ejection of the sheet above the ejection tray, and the second arm pivots in the direction of ejection of the sheet about the first connecting portion and the second connecting portion to move the second lower end portion downstream of the first connecting portion in the direction of ejection of the sheet above the ejection tray and pull out the push tray downstream in the direction of ejection of the sheet along the ejection tray.

7. The sheet conveying device according to claim 6, wherein
a support wall capable of supporting a trailing end of the sheet ejected to the ejection tray stands at an upstream end of the push tray in the direction of ejection of the sheet,
an opening through the ejection tray is provided at an upstream end of the ejection tray in the direction of ejection of the sheet,
a push tray housing that accommodates the push tray to allow the push tray to slide in the direction of ejection of the sheet and a direction opposite to the direction of ejection of the sheet is provided under the ejection tray,
the push tray is accommodated in the push tray housing to allow the support wall to pass through the opening in the ejection tray and become exposed above from the ejection tray, and
when the push tray is moved downstream in the direction of ejection of the sheet by pivoting of the second arm in the direction of ejection of the sheet, the support wall moves downstream in the direction of ejection of the sheet within the opening.
